(19) United States
(12) Patent Application Publication
(10) Pub. No.: US 2026/0336979 A1
(43) Pub. Date: Oct. 29, 2026

(54) DEVICE FOR CARRYING A DRIVE MOTOR OF AN ELEVATOR SYSTEM

(71) Applicant: Inventio AG, Hergiswil (CH)

(72) Inventors: Romeo Lo Jacono, Gravesano (CH); Alessandro D'Apice, Ebikon (CH); Mark Bezmalinovic, Zug (CH)

(21) Appl. No.: 19/114,498

(22) PCT Filed: Sep. 28, 2023
(86) PCT No.: PCT/EP2023/076905

§ 371 Date: Mar. 24, 2025

(30) Foreign Application Priority Data
Sep. 30, 2022 (EP) 22199116.9

(51) Int. Cl. B66B 11/00

(52) U.S. Cl. CPC B66B 11/0045

(57) ABSTRACT

A device for carrying a drive motor of an elevator system includes a carrier with a receptacle for fastening the drive motor to the carrier, a bracket, and a support. The device, in the assembled state, has the carrier fastened by one of its ends to a side wall of a shaft of the elevator system, with the receptacle arranged on a portion, projecting into the shaft, of the carrier, and with bracket fastened to the same side wall as the carrier and is arranged below the carrier. In this case, the support supports the portion, projecting into the shaft, of the carrier on a portion, projecting into the shaft, of the bracket.

### FIELD

The present invention relates to a device for carrying a drive motor of an elevator system. Furthermore, the invention relates to a method for mounting the device. Further, the invention relates to a system for carrying a plurality of drive motors of an elevator system, and to an elevator system.

### BACKGROUND

An elevator system, as used to transport persons and/or goods in buildings, may comprise a drive motor for raising and/or lowering the car and/or a counterweight connected to the car. Such a drive motor can, for example, be arranged in a shaft head by means of a carrier structure.

EP 2 361 214 B1 describes a carrier structure which is formed by a cross member arranged in the shaft and a longitudinal member for supporting the cross member on a carrying element of the shaft.

U.S. Pat. No. 6,006,865 describes a carrier structure that can be swung into the shaft for maintenance and repair purposes.

U.S. Pat. No. 6,446,762 B1 describes a carrier structure in the form of a two-part frame that can be fastened to an upper end of the shaft.

US 2004/0084251 A1 describes a carrier structure that can be fastened to an upper end of a guide rail.

There may be a need for an alternative device for carrying a drive motor of an elevator system. Furthermore, there may be a need for a system for carrying a plurality of drive motors of an elevator system—for example, to enable the use of a plurality of smaller drive motors instead of a single larger drive motor to move the car.

### SUMMARY

These needs can be addressed by the subject matter of the advantageous embodiments defined in the following description, and in the accompanying drawings.

A first aspect of the invention relates to a device for carrying a drive motor of an elevator system, which comprises a shaft connecting several stories of a building and a car that can be moved in the shaft between the stories by means of the drive motor. The device comprises a carrier with a receptacle for fastening the drive motor to the carrier, a bracket, and a support. The device is designed or configured such that, in the assembled state of the device, the carrier is fastened with one of its ends to a side wall of the shaft, the receptacle is arranged on a portion, projecting into the shaft, of the carrier, and the bracket is fastened to the side wall, in particular to the same side wall as the carrier, and is arranged below the carrier. In this case, the support supports the portion, projecting into the shaft, of the carrier on a portion, projecting into the shaft, of the bracket.

In the assembled state, the device can be arranged at least partially in a shaft head, i.e., in an upper end of the shaft. The height of the shaft head can, for example, correspond to a vertical distance from a ceiling of the shaft to a floor of an uppermost story. However, other installation sites are also possible.

For example, the shaft can be delimited by four different side walls, which can be arranged opposite each other in pairs. In other words, the shaft can have a rectangular cross-section. In the assembled state of the device, the carrier and the bracket can be fastened to one of these four side walls.

The carrier and/or the bracket can be fastened to the side wall—for example, by screwing. It is also possible that a portion of the carrier and/or the bracket is embedded in the side wall, e.g., by being concreted into it, while another portion of the carrier or bracket projects from the side wall.

The receptacle can, for example, be arranged at a free end of the carrier. In this case, the drive motor can be fastened to the carrier via the receptacle in such a way that the drive motor, viewed in the longitudinal direction of the carrier, projects beyond the free end of the carrier in a direction away from the side wall. However, the receptacle can also be arranged at another location of the carrier, e.g., between the free end and the (fixed) end, with which the carrier is attached to the side wall when the device is assembled.

The carrier can be designed to additionally carry at least one further drive component of the elevator system—for example, a drive battery, a brake chopper, an elevator controller, a gear, a traction sheave, and/or a deflection pulley.

The support may be designed to bear at least part of a weight force of the carrier fastened to the side wall and having the drive motor (and additionally one or more other drive components). When the device is assembled, the support can be connected, e.g., screwed and/or welded, to the carrier on the one hand and to the bracket on the other.

It is possible that the carrier has a horizontal longitudinal direction in the assembled state of the device and/or the support has a vertical longitudinal direction in the assembled state of the device.

Because the carrier and the bracket are fastened to the same side wall, the device can be installed more easily compared with carrier structures whose parts have to be mounted on different side walls. In addition, the device can thereby be designed in a more space-saving manner.

A second aspect of the invention relates to a system for carrying a plurality of drive motors of an elevator system, which comprises a shaft connecting several stories of a building and a car which can be moved in the shaft between the stories by means of the drive motors. The system comprises a plurality of devices, wherein each device is the device described above and below, and the carrier of each device has a receptacle for fastening one of the drive motors to the carrier.

In other words, the system may include a separate device for each drive motor. The devices can, for example, be mounted independently of one another.

It is possible that the carriers are arranged at the same height in the shaft when the system is assembled. Additionally or alternatively, the brackets can be arranged at the same height in the shaft when the system is assembled. However, an embodiment is also conceivable in which the height positions of the carriers or brackets differ significantly from one another.

Such a system enables simple and space-saving mounting of a plurality of drive motors in the shaft—for example, in the shaft head. This means that, instead of a single larger drive motor, several smaller drive motors can be used to move the car, which can have a positive effect on manufacturing costs and/or maintenance and/or repair costs.

A third aspect of the invention relates to an elevator system which comprises a shaft connecting several stories of a building and a car which can be moved in the shaft between the stories.

The elevator system further comprises a drive motor for moving the car and the device described above and below, wherein the drive motor is fastened to the carrier via the receptacle.

Alternatively, the elevator system further comprises a plurality of drive motors for moving the car, and the system described above and below, wherein each drive motor is fastened to one of the carriers via one of the receptacles.

In addition, the elevator system may comprise a counterweight coupled to the car via support means, which counterweight is lowered when the car is raised, and is raised when the car is lowered. In this case, the drive motor or motors can be designed to displace the support means.

A fourth aspect of the invention relates to a method for mounting a device for carrying a drive motor of an elevator system, in particular the device described above and below, wherein the elevator system comprises a shaft connecting several stories of a building and a car that can be moved in the shaft between the stories by means of the drive motor. The method comprises the following steps: providing a bracket, a support, and a carrier with a receptacle for fastening the drive motor to the carrier; fastening the bracket and the carrier with one of its ends to the side wall, in particular the same side wall, and/or the ceiling of the shaft, wherein the bracket fastened to the side wall is arranged below the carrier, in particular the carrier fastened to the side wall, and the receptacle is arranged on a portion, projecting into the shaft, of the carrier, in particular the carrier fastened to the side wall; connecting the support to the carrier and the bracket, so that the support supports the portion, projecting into the shaft, of the carrier on a portion, projecting into the shaft, of the bracket.

The above steps can be performed in the order given or in a different order than the one given.

It should be noted that features of the device described above and below may also be features of the method (and vice versa).

Embodiments of the invention may be considered to be based upon the concepts and findings described below. These embodiments are not to be understood as limiting the scope of the invention.

According to one embodiment, the support can be formed by a longitudinal portion of a guide rail for guiding the car in the longitudinal direction of the shaft. When the device is assembled, the longitudinal portion can be fastened to the carrier on the one hand and to the bracket on the other. This means that no additional component is required to support the carrier on the bracket.

According to one embodiment, the guide rail may be a hollow rail. Such a guide rail is particularly rigid and stable.

According to one embodiment, the longitudinal portion can be an end portion of the guide rail. In other words, the carrier can be arranged at an upper end of the guide rail when the device is in the assembled state. For example, the carrier can rest on the upper end of the guide rail.

According to one embodiment, the bracket can be anchored in a floor and/or on a side wall directly at the floor of one of the stories when the device is in the assembled state. In this case, the bracket can be connected to the floor directly and/or indirectly, i.e., via at least one connecting part—for example, in the form of a carrier or a plate. The floor can, for example, be the floor of an uppermost of the stories. This allows a particularly stable fastening of the bracket to the side wall.

According to one embodiment, the carrier can rest on an upper end of the support in the assembled state of the device. In this case, the upper end of the support can touch the underside of the carrier.

However, the underside of the carrier can also be connected to the upper end of the support via at least one connecting part—for example, in the form of an intermediate plate arranged between the carrier and the support. When the device is in the assembled state, the connecting part can be fastened to the carrier and/or the support—for example, screwed and/or welded thereto. The connecting part can also comprise a fastening portion for additionally fastening the drive motor to the connecting part. This enables a statically determined mounting of the drive motor at two mounting points, viz., the receptacle on the carrier and the fastening portion.

According to one embodiment, the device can further comprise an additional support which, in the assembled state of the device, additionally supports the portion, projecting into the shaft, of the carrier on the portion, projecting into the shaft, of the bracket. Similarly to the support, the additional support can be connected to the carrier on the one hand and to the bracket on the other when the device is assembled. When the device is in the assembled state, the additional support can extend horizontally at least in portions between the support and the side wall and/or vertically at least in portions between the carrier and the bracket. The fact that the supporting makes use of multiple supports, i.e., two or more than two, means that the supports can each be made lighter and/or simpler than if only a single support is used. This also makes the supporting more reliable.

According to one embodiment, the device may further comprise a plate-like wall element which is designed such that, in the assembled state of the device, it extends at least partially between the support and the side wall.

According to one embodiment, the wall element can be designed such that, in the assembled state of the device, it covers at least 50%, preferably at least 75%, of an area which is delimited in the horizontal direction by the support and the side wall, and in the vertical direction by the carrier and the bracket. This can be advantageous for safety and/or aesthetic reasons.

According to one embodiment, a width of a portion of the wall element extending between the support and the side wall in the horizontal direction can be at least 50%, preferably at least 75%, of a horizontal distance of the support to the side wall. This can be advantageous for weight and/or stability reasons.

According to one embodiment, the wall element can have a plurality of recesses, the respective width of which can be at least 25%, preferably at least 50%, of a width of the wall element and/or the respective height of which can be at least 10%, preferably at least 25%, of a height of the wall element. This allows the weight of the wall element to be reduced considerably.

According to one embodiment, the wall element may be a sheet metal part. This enables a cost-effective production of the wall element.

According to one embodiment, the additional support can be formed by the wall element. This means that no additional component is required besides the wall element to additionally support the carrier on the bracket.

According to one embodiment, the end, fastened to the side wall and/or the ceiling, of the carrier can be fastened to the side wall and/or the ceiling via at least one vibration-damping, intermediate piece. Such an intermediate piece can, for example, be or include a rubber part. This means that unwanted vibrations and/or noises during operation of the drive motor can be noticeably reduced or avoided.

According to one embodiment, the carriers of different devices can be fastened to the same side wall of the shaft in the assembled state of the system. In other words, all carriers and brackets of the system can be fastened to the same side wall of the shaft.

Alternatively, at least one of the carriers may be attached to a different side wall than the remaining carrier(s), and/or at least one of the brackets may be fastened to a different side wall than the remaining bracket(s).

According to one embodiment, in the assembled state of the system, at their portions projecting into the shaft, the carriers can be connected to one another, via at least one connecting part, to form a frame. The connecting part can, for example, be in the form of a plate or a carrier. Thus, the rigidity of the carriers can be significantly increased with little design effort compared to embodiments in which the carriers are not connected to each other to form a frame.

Similarly, when the system is assembled, the brackets can be connected to each other via a connecting part—for example, in the form of a plate or carrier. In this case, the brackets can be fastened to the side wall via the (common) connecting part. The connecting part can also be designed to anchor the brackets in a floor of one of the stories (see above). For this purpose, the connecting part can be at least partially fastened to the floor, e.g., to a front edge, adjacent to the side wall or projecting over the side wall into the shaft, of the floor.

Embodiments of the invention will be described below with reference to the accompanying drawings. Neither the description nor the drawings are to be understood as limiting the scope of the invention.

### DESCRIPTION OF THE DRAWINGS

FIG. 1 shows a portion of an elevator system according to an embodiment of the invention.

FIG. 2 is a perspectival view of a system carrying two drive motors of an elevator system, according to one embodiment of the invention.

FIG. 3 is a perspectival view of a system carrying two drive motors of an elevator system, according to an alternative embodiment of the invention.

FIG. 4 is a plan view of a carrier, fastened to a shaft wall via a plurality of vibration-damping, intermediate pieces, of a device according to an embodiment of the invention.

The drawings are purely schematic and are not to scale. Where the same reference signs are used in different drawings, these reference signs denote identical or equivalent features.

### DETAILED DESCRIPTION

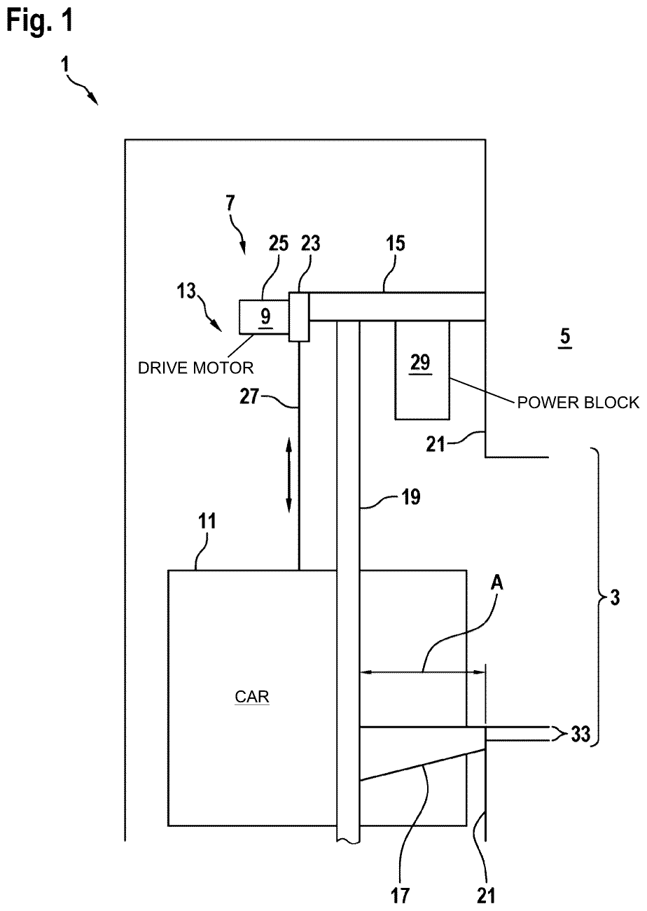

FIG. 1 shows an elevator system 1 which comprises a shaft 7 connecting several stories 3 of a building 5 and a car 11 which can be moved in the shaft 7 by means of a drive motor 9. In addition, the elevator system 1 comprises a device 13 for positioning the drive motor 9 in the shaft 7—here, in a shaft head.

The device 13 comprises a carrier 15, a bracket 17, and a support 19. In the assembled state of the device 13 shown in FIG. 1, the carrier 15 is fastened with one of its ends to a side wall 21 of the shaft 7, so that a portion of the carrier 15 projects from the side wall 21 into the shaft 7. In this portion, which here has a horizontal longitudinal direction, the carrier 15 has a receptacle 23 for fastening the drive motor 9 to the carrier 15. As shown in FIG. 1, the receptacle 23 can be arranged at a free end of the portion, projecting into the shaft 7, of the carrier 15.

The bracket 17 is attached to the same side wall 21 as the carrier 15 and is located below the carrier 15. In this case, the bracket 17 can be located below and the carrier 15 above a door opening through which the shaft 7 is accessible to persons from one of the stories 3.

The support 19 is connected, e.g., screwed and/or welded, on the one hand to the portion, projecting into the shaft 7, of the carrier 15, and on the other to a portion, projecting into the shaft 7, of the bracket 17. Thus, the carrier 15 is supported on the bracket 17 via the support 19.

The drive motor 9 is attached to the carrier 15 via the receptacle 23. In this example, the drive motor 9 is carried exclusively by the device 13, i.e., held at a defined position in the shaft 7. The receptacle 23 can additionally be supported on the support 19 and/or the bracket 17.

The drive motor 9 can comprise a housing 25 and, via its housing 25, be fastened to the receptacle 23. Additional drive components such as a gear and/or a drive pulley for displacing a support means 27 connected to the car 11 and/or to a counterweight can be arranged in and/or on the housing 25.

What is known as a power block 29 can additionally be fastened to the portion, projecting into the shaft 7, of the carrier 15—for example, between the support 19 and the side wall 21. Such a power block 29 may, for example, comprise a battery, a brake chopper, an elevator controller, or a combination of at least two of these examples.

In this example, the support 19 is formed by a longitudinal portion of a guide rail 19, preferably in the form of a hollow rail, for guiding the car 11 in the longitudinal direction of the shaft 7. In this case, the carrier 15 can, as shown here, rest on the upper end of the guide rail 19. The guide rail 19 can be designed to additionally support the bracket 17.

The bracket 17 can be anchored in a floor 33 of one of the stories 3—here, the top story 3. Alternatively or additionally, the bracket 17 can be anchored in a portion, located outside the floor 33—for example, adjacent to the floor 33—of the side wall 21.

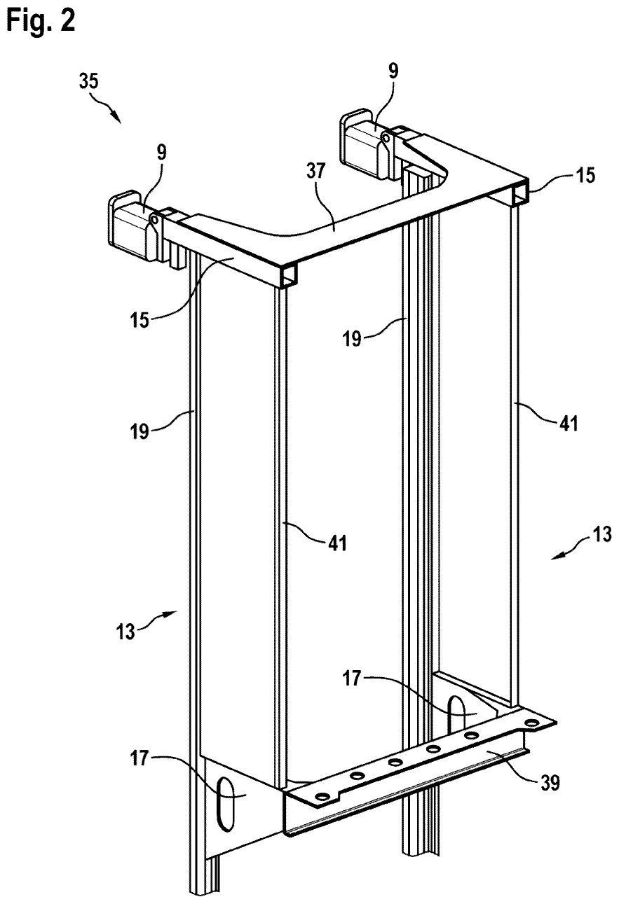

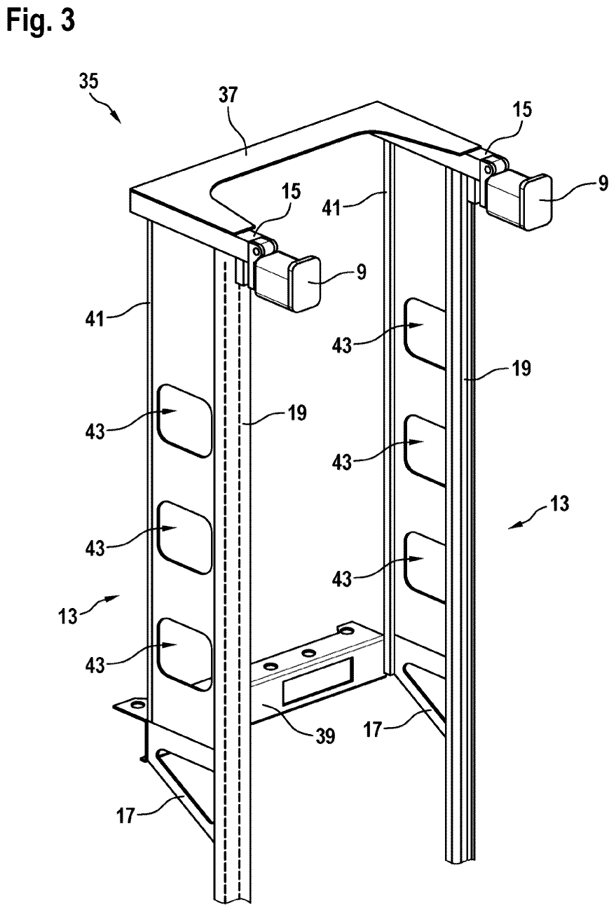

The elevator system 1 can also comprise two or more than two (preferably identical) examples of the device 13 described above, which then form a system 35 for carrying two or more than two drive motors 9 of the elevator system 1 (see FIG. 2 and FIG. 3). In this case, each of the drive motors 9 can be connected to one of the carriers 15 via one of the receptacles 23, i.e., each drive motor 9 can be carried by its own device 13.

As can be seen in FIG. 2 and FIG. 3, the carriers 15 of the system 35, via at least one connecting part 37, here in the form of a connecting plate, can be connected to one another at their portions projecting into the shaft 7 to form a particularly torsion-resistant frame.

In a similar manner, the brackets 17 of the system 35 can be connected to one another via at least one connecting part—here, in the form of a cross member 39. In this example, each bracket 17 is connected at one of its ends to the cross member 39, wherein the cross member 39 on the other hand can be fastened to the side wall 21, preferably anchored in the floor 33. At its other end, however, the bracket 17 is connected to one of the supports 19—here, to one of the guide rails 19.

It is possible for each carrier 15 to be supported on the respective bracket 17 via an additional support 41, wherein the additional support 41 can be fastened on the one hand to the portion, projecting into the shaft 7, of the carrier 15, and on the other to the portion, projecting into the shaft, of the bracket 17. In addition, the additional support 41 can be attached to the support 19 and/or the side wall 21.

The additional support 41 can, as shown in FIG. 2, be designed as a largely closed, plate-like wall element 41 in the form of a sheet metal part which, in the assembled state of the device 13, covers a majority, i.e., at least 50% or even at least 75%, of an area which is delimited in the horizontal direction by the support 19 and the side wall 21, and in the vertical direction by the carrier 15 and the bracket 17.

In this case, a portion of the wall element 41 extending between the support 19 and the side wall 21 can have a width which is at least 50% or even at least 75% of a horizontal distance A (see FIG. 1) of the support 19 to the side wall 21.

As shown in FIG. 3, the wall element 41 can, for reasons of weight and/or stability, have several (here, three) relatively large recesses 43, the respective width of which can be at least 25% or even at least 50% of the width of the wall element 41 (or the distance A) and/or the respective height of which can be at least 10% or even at least 25% of the height of the wall element 41 (or a vertical distance of the bracket 17 to the carrier 15).

The carriers 15 of different devices 13 can be arranged at the same height in the shaft 7 in the assembled state of the system 35. Additionally or alternatively, the brackets 17 of different devices 13 can be arranged at the same height in the shaft 7 when the system 35 is assembled.

In the assembled state of the system 35, the car 11 can be arranged between the supports 19 or guide rails 19.

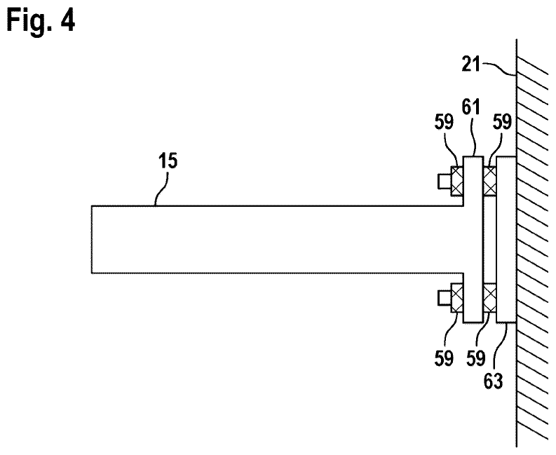

As shown in FIG. 4, the carrier 15 can also be coupled at its fixed end to the side wall 21 via at least one vibration-damping, intermediate piece 59. In this example, the carrier 15 has at its fixed end a flange 61, which can be screwed to a counter plate 63 attached to the side wall 21, wherein the flange 61 and the counter plate 63 do not touch directly in the screwed state, but are coupled to one another via several intermediate pieces 59. The intermediate pieces 59 can, for example, be designed as rubber spacers through which a screw can be passed.

Finally, it should be noted that terms such as “having,” “comprising,” “including,” “with,” etc., do not exclude other elements or steps, and indefinite articles such as “a” or “an” do not exclude a plurality. Furthermore, it should be noted that features or steps that are described with reference to one of the above embodiments may also be used in combination with features or steps that are described with reference to others of the above embodiments.

In accordance with the provisions of the patent statutes, the present invention has been described in what is considered to represent its preferred embodiment. However, it should be noted that the invention can be practiced otherwise than as specifically illustrated and described without departing from its spirit or scope.

1-14. (canceled)

15. A device for carrying a drive motor of an elevator system, the elevator system including a shaft connecting several stories of a building and a car movable in the shaft between the stories by the drive motor, the device comprising:
a carrier with a receptacle adapted to fasten the drive motor to the carrier, a bracket, and a support; and
wherein, in an assembled state of the device, the carrier is fastened by one end to a side wall and/or a ceiling of the shaft, the receptacle is arranged on a portion, projecting into the shaft, of the carrier, the bracket is fastened to the side wall and is arranged below the carrier, and the support supports the portion, projecting into the shaft, of the carrier on a portion, projecting into the shaft, of the bracket.

16. The device according to claim 15 wherein the support is a longitudinal portion of a guide rail guiding the car in a longitudinal direction of the shaft.

17. The device according to claim 16 wherein the guide rail is a hollow rail and/or wherein the longitudinal portion is an end portion of the guide rail.

18. The device according to claim 15 wherein the bracket is anchored in a floor and/or on the side wall directly adjacent the floor of one of the stories in the assembled state of the device.

19. The device according to claim 18 wherein the one of the stories is a top story.

20. The device according to claim 15 wherein the carrier rests on an upper end of the support in the assembled state of the device.

21. The device according to claim 15 including an additional support further supporting the portion, projecting into the shaft, of the carrier on the portion, projecting into the shaft, of the bracket.

22. The device according to claim 15 including a wall element that, in the assembled state of the device, extends at least in portions between the support and the side wall and at least one of:
wherein the wall element covers at least 50% of an area delimited in a horizontal direction by the support and the side wall and in a vertical direction by the carrier and the bracket;
wherein a width of a portion of the wall element extending between the support and the side wall in the horizontal direction is at least 50% of a horizontal distance of the support to the side wall; and
wherein the wall element includes a plurality of recesses each with a width of at least 25% of a width of the wall element, and/or a height of at least 10% of a height of the wall element.

23. The device according to claim 15 including a wall element that, in the assembled state of the device, extends at least in portions between the support and the side wall and at least one of:
wherein the wall element covers at least 75% of an area delimited in a horizontal direction by the support and the side wall and in a vertical direction by the carrier and the bracket;
wherein a width of a portion of the wall element extending between the support and the side wall in the horizontal direction is at least 75% of a horizontal distance of the support to the side wall; and
wherein the wall element includes a plurality of recesses each with a width of at least 50% of a width of the wall element, and/or a height of at least 25% of a height of the wall element.

24. The device according to claim 15 including a wall element that, in the assembled state of the device, extends at least in portions between the support and the side wall and is a sheet metal part.

25. The device according to claim 15 including an additional support further supporting the portion, projecting into the shaft, of the carrier on the portion, projecting into the shaft, of the bracket, and wherein the additional support is formed by a wall element that, in the assembled state of the device, extends at least in portions between the support and the side wall.

26. The device according to claim 15 wherein the one end of the carrier is fastened to the side wall and/or to the ceiling via at least one vibration-damping, intermediate piece.

27. A system for carrying a plurality of drive motors of an elevator system, the elevator system including a shaft connecting several stories of a building and a car movable in the shaft between the stories by the drive motors, the system comprising:
at least two of the devices according to claim 15; and
wherein the carrier of each of the devices has the receptacle adapted to fasten one of the drive motors to the carrier.

28. The system according to claim 27 wherein the carriers are each fastened to the side wall of the shaft in an assembled state of the system.

29. The system according to claim 27 wherein the carriers, in the assembled state of the system, at the portions projecting into the shaft, are connected to one another via a connecting part thereby forming a frame.

30. An elevator system comprising:
a shaft connecting several stories of a building;
a car movable in the shaft between the stories;
a drive motor moving the car; and
the device according to any of claim 15 wherein the drive motor is fastened to the carrier of the device via the receptacle of the device.

31. The elevator system according to claim 30 including:
another drive motor moving the car; and
another of the device wherein the another drive motor is fastened to the carrier of the another device via the receptacle of the another device.

32. A method for mounting a drive motor of an elevator system, wherein the elevator system includes a shaft connecting several stories of a building and a car movable in the shaft between the stories by the drive motor, the method comprising steps of:
providing the device according to claim 15 having the bracket, the support, and the carrier with the receptacle for fastening the drive motor to the carrier;
fastening the bracket and the carrier with one end to a side wall, wherein the bracket fastened to the side wall is arranged below the carrier fastened to the side wall, and the receptacle is arranged on a portion, projecting into the shaft, of the carrier; and
connecting the support to the carrier and to the bracket such that the support supports the portion, projecting into the shaft, of the carrier on a portion, projecting into the shaft, of the bracket.
